(19) United States
(12) Patent Application Publication
(10) Pub. No.: US 2024/0040438 A1
(43) Pub. Date: Feb. 1, 2024

(54) QOS SPLITTING AND CARRYING METHODS, OBJECT SIDE QOS DETERMINATION METHOD, AND UE

(71) Applicant: Sharp Kabushiki Kaisha, Sakai City, Osaka (JP)

(72) Inventors: Lei LIU, Shanghai (CN); Renmao LIU, Shanghai (CN)

(21) Appl. No.: 18/268,435

(22) PCT Filed: Dec. 20, 2021
(86) PCT No.: PCT/CN2021/139636

§ 371 Date: Jun. 20, 2023

(30) Foreign Application Priority Data
Dec. 24, 2020 (CN) 202011555194.3

(51) Int. Cl. H04W 28/24

(52) U.S. Cl. CPC H04W 28/24

(57) ABSTRACT

Provided in the present invention are a QoS splitting method, a QoS carrying method, and an object side QoS determination method performed by user equipment to guarantee sidelink relay quality of service, and corresponding user equipment. The QoS splitting method is used to split QoS between a source side remote UE and a target end node into source side QoS and target side QoS, and includes: determining a communication status comparison result of a source side channel and a target side channel on the basis of a source side channel indicator and a target side channel indicator; when the communication status comparison result indicates that a communication status of the source side channel is superior to a communication status of the target side channel, causing the source side QoS to be higher than the target side QoS; and when the communication status comparison result indicates that the communication status of the source side channel is inferior to the communication status of the target side channel, causing the source side QoS to be lower than the target side QoS.

### TECHNICAL FIELD

The present invention relates to the technical field of wireless communications. More specifically, the present invention relates to a QoS splitting method, a QoS carrying method, and an object side QoS determination method performed by user equipment, and corresponding user equipment.

### BACKGROUND

At the 3rd Generation Partnership Project (3GPP) RAN #80 plenary meeting in June 2018, the subject of the study on feasibility of V2X employing 5G NR network technology of Release 16 (see non-patent literature: RP-181480, New SID Proposal: Study on NR V2X) was approved. The primary function included in NR V2X of Release 16 is to support unicast, multicast, and broadcast in out-of-coverage and in-coverage scenarios.

At the RAN #86 plenary meeting in December 2019, a study item on NR sidelink relaying of Release 17 was proposed (see non-patent literature: RP-193253, New Study Item on NR Sidelink Relaying), and was approved. Regarding the latest release of the study item, see non-patent literature: RP-201474, Revised SID: NR Sidelink Relay. The study item mainly studies the solution to user equipment (UE)-to-network and UE-to-UE relaying, so as to extend sidelink-based coverage. One of the goals of the study item is to support sidelink relay quality of service (QoS) requirements.

In the NR sidelink relaying study item of Release 17, both UE-to-network and UE-to-UE relay architectures need to guarantee end-to-end QoS requirements. End-to-end QoS guarantee parameters may be negotiated by means of signaling exchange between UE and UE and between UE and a network. Relay UE may split the end-to-end QoS requirements, so as to guarantee QoS requirements segment by segment, thereby meeting the end-to-end QoS requirements.

The present invention discusses the related problem of how remote UE and relay UE guarantee QoS requirements.

### SUMMARY

An objective of the present invention is to provide a QoS splitting method, a QoS carrying method, and an object side QoS determination method performed by user equipment to guarantee sidelink relay quality of service, and corresponding user equipment.

According to an aspect of the present invention, provided is a QoS splitting method performed by a relay UE, the method being used to split QoS between a source side remote UE and a target end node into source side QoS and target side QoS, the source side QoS being QoS requirements on source side service data transmission between the source side remote UE and the relay UE, and the target side QoS being QoS requirements on target side service data transmission between the relay UE and the target end node, the method comprising: determining a communication status comparison result of a source side channel and a target side channel on the basis of a source side channel indicator and a target side channel indicator; when the communication status comparison result indicates that a communication status of the source side channel is superior to a communication status of the target side channel, causing the source side QoS to be higher than the target side QoS; and when the communication status comparison result indicates that the communication status of the source side channel is inferior to the communication status of the target side channel, causing the source side QoS to be lower than the target side QoS.

Optionally, the source side channel indicator and the target side channel indicator may be of the same type, and the determining a communication status comparison result of a source side channel and a target side channel on the basis of a source side channel indicator and a target side channel indicator may comprise: determining the communication status comparison result of the source side channel and the target side channel on the basis of direct comparison between the source side channel indicator and the target side channel indicator.

Optionally, the source side channel indicator and the target side channel indicator may be of different types, and the determining a communication status comparison result of a source side channel and a target side channel on the basis of a source side channel indicator and a target side channel indicator may comprise: multiplying the source side channel indicator and the target side channel indicator by coefficients corresponding thereto, respectively, and then comparing acquired products to determine the communication status comparison result of the source side channel and the target side channel.

Optionally, the target end node may be a base station, the source side channel indicator may comprise source side SL-RSRP or source side SD-RSRP of the source side channel, the target side channel indicator may comprise target side RSRP of the target side channel, and the determining a communication status comparison result of a source side channel and a target side channel on the basis of a source side channel indicator and a target side channel indicator may comprise: when the source side SL-RSRP or the source side SD-RSRP is higher than the target side RSRP, determining that the communication status of the source side channel is superior to the communication status of the target side channel; and/or, when the source side SL-RSRP or the source side SD-RSRP is lower than the target side RSRP, determining that the communication status of the source side channel is inferior to the communication status of the target side channel.

Optionally, the target end node may be a target side remote UE, the source side channel indicator may comprise source side SL-RSRP or source side SD-RSRP of the source side channel, the target side channel indicator may comprise target side SL-RSRP or target side SD-RSRP of the target side channel, and the determining a communication status comparison result of a source side channel and a target side channel on the basis of a source side channel indicator and a target side channel indicator may comprise: when the source side channel indicator is higher than the target side channel indicator, determining that the communication status of the source side channel is superior to the communication status of the target side channel; and/or, when the source side channel indicator is lower than the target side channel indicator, determining that the communication status of the source side channel is inferior to the communication status of the target side channel.

Optionally, the target end node may be target side remote UE, the source side channel indicator may comprise a source side CBR of the source side channel, the target side channel indicator may comprise a target side CBR of the target side channel, and the determining a communication status comparison result of a source side channel and a target side channel on the basis of a source side channel indicator and a target side channel indicator may comprise: when the source side CBR is lower than the target side CBR, determining that the communication status of the source side channel is superior to the communication status of the target side channel; and/or, when the source side CBR is higher than the target side CBR, determining that the communication status of the source side channel is inferior to the communication status of the target side channel.

According to another aspect of the present invention, provided is a QoS information carrying method performed by a remote UE, comprising: acquiring sidelink DRB configuration information comprising QoS flow identifier indication information indicating whether a QoS flow identifier needs to be carried in a sidelink SDAP data PDU; and when it is determined, on the basis of the QoS flow identifier indication information, that the QoS flow identifier needs to be carried in the sidelink data PDU, constructing the sidelink SDAP data PDU having the QoS flow identifier, the QoS flow identifier indicating QoS information about a QoS flow bearing service data transmission between the remote UE and a relay UE, and being used by the relay UE to determine object side QoS information for bearing service data transmission between the relay UE and an object side node and corresponding to the QoS flow, QoS between the remote UE and the object side node being split into source side QoS and corresponding target side QoS by using the method according to any one of claims 1 to 4, the QoS flow identifier indicating one of the source side QoS and the corresponding target side QoS, and the object side QoS information being the other one of the source side QoS and the corresponding target side QoS.

Optionally, the method further comprises: when data needs to be transmitted, determining whether the data to be transmitted needs to be relayed; and when the data to be transmitted needs to be relayed, constructing the sidelink SDAP data PDU having the QoS flow identifier.

Optionally, the QoS flow identifier indication information may be sidelink SDAP header indication information indicating whether the sidelink SDAP data PDU needs to comprise an SDAP header, the SDAP header comprises the QoS flow identifier, and configuring the sidelink SDAP data PDU having the QoS flow identifier may comprise: constructing the sidelink SDAP data PDU comprising the SDAP header according to a format comprising an SDAP header.

According to another aspect of the present invention, further provided is an object side QoS information determination method performed by a relay UE, comprising: when a change operation is performed on a source side channel and/or a target side channel, storing a channel mapping relationship between an existing source side channel and a corresponding target side channel, the target side channel being a channel between the relay UE and a target end node, the source side channel being a channel between a source side remote UE and the relay UE, and the mapping relationship being determined on the basis of source side QoS of the source side channel and target side QoS of the corresponding target side channel; and when data is received from the remote UE, determining, according to the channel mapping relationship and reception side QoS of a reception side channel for receiving the data, an object side channel corresponding to the reception side channel and used to transmit the data to an object side node, the reception side QoS being one of source side QoS and target side QoS between the remote UE and the object side node, and the object side QoS being the other, and information about the source side QoS and corresponding information about the target side QoS being acquired by means of splitting using the method according to any one of claims 1 to 4.

Optionally, the method further comprises: if no corresponding object side channel can be determined according to the channel mapping relationship, creating, on the basis of the object side QoS corresponding to the reception side QoS, an object side channel corresponding to the reception side channel and used to transmit the data to the object side node, and by means of the created object side channel.

According to another aspect of the present invention, further provided is user equipment, comprising: a processor; and a memory storing instructions, wherein the instructions, when run by the processor, perform the method provided in each of the above aspects.

The method according to the present invention allows QoS of a channel between a source side remote UE and a target end node to be reasonably split. Further, corresponding source side QoS and target side QoS can be accurately determined in the channel of which QoS has been split.

### BRIEF DESCRIPTION OF THE DRAWINGS

FIG. 1 is a schematic diagram for illustrating remote UEs and a relay UE according to the present invention.

FIG. 2 is a schematic diagram for illustrating various UE-to-network relay scenarios according to the present invention.

FIG. 3 is a schematic diagram for illustrating a UE-to-network relay architecture according to the present invention.

FIG. 4 is a schematic diagram for illustrating a UE-to-UE relay architecture according to the present invention.

FIG. 5 is a schematic diagram for illustrating an example of an SDAP header format according to the present invention.

FIG. 6 is a schematic diagram for illustrating another example of an SDAP header format according to the present invention.

FIG. 7 is a schematic structural block diagram of user equipment (UE) according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications, such as TS38.300, TS38.331, TS36.300, TS36.331, etc. The terms involved in the present invention shall have the meanings set forth below, unless otherwise indicated.
UE: User Equipment
NR: New Radio
RRC: Radio Resource Control
RRC CONNECTED: RRC connected state
RRC INACTIVE: RRC inactive state
RRC IDLE: RRC idle state
RAN: Radio Access Network
Sidelink: Sidelink Communication
SL: Sidelink
SDAP: Service Data Adaptation Protocol
SCI: Sidelink Control Information
RSRP: Reference Signal Receiving Power
PSCCH: Physical Sidelink Control Channel
PSSCH: Physical Sidelink Shared Channel
AS: Access Stratum
DL: Downlink
IE: Information Element
CE: Control Element
MIB: Master Information Block
NR: New Radio
SIB: System Information Block
DMRS: Dedicated Demodulation Reference Signal
SD-RSRP: Sidelink Discovery Reference Signal Received Power
SL-RSRP: Sidelink RSRP, Sidelink Reference Signal Received Power
QoS: Quality of Service
CBR: Channel Busy Rate
NG-RAN: NG Radio Access Network
5G Core Network
PDU: Protocol Data Unit
SDU: Service Data Unit
PQFI: PC5 QoS Flow ID, PC5 QoS Flow Identifier
QFI: QoS Flow ID, QoS Flow Identifier
5G QoS Identifier
PQI: PC5 QoS Identifier
NAS: Non-Access Stratum
DRB: Data Radio Bearer
RLC: Radio Link Control

In the present invention, a network, a base station, and a RAN may be used interchangeably. The network may be a Long Term Evolution (LTE) network, a New RAT (NR) network, an enhanced Long Term Evolution (eLTE) network, or another network defined in a subsequent evolved version of the 3GPP.

In the present invention, user equipment (UE) may refer to an NR device that supports an NR sidelink relaying function as described in the background, or an NR device or an LTE device of another type.

A PC5 interface is an interface for performing control plane and user plane sidelink communication between UE and UE. For sidelink unicast, a PC5-RRC connection is an AS layer logical connection between a pair of a source layer-2 ID and a target layer-2 ID. Setup of one PC5 unicast link corresponds to setup of one PC5-RRC connection.

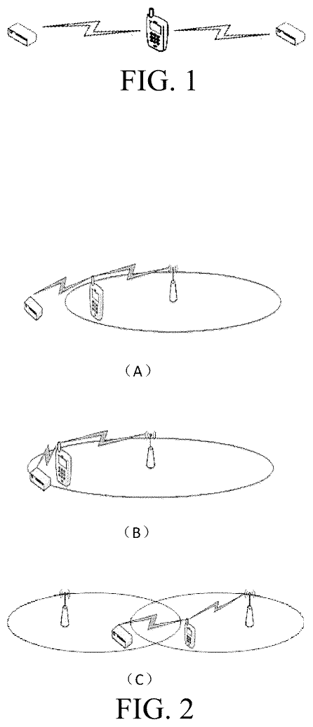

UE-to-UE relaying is as shown in FIG. 1. On the left and the right are remote UEs, and in the middle is a relay UE. The remote UEs are respectively connected to the relay UE by means of PC5 interfaces. Because the two remote UEs are far from each other or because the communication environment is poor, the relay UE is needed to relay and forward signaling and data between the two remote UEs.

UE-to-UE relay scenarios include:
1) in coverage range: two remote UEs (i.e., source side UE and target side UE) and a relay UE are all in the coverage range;
2) out of coverage range: two remote UEs (i.e., source side UE and target side UE) and a relay UE are all out of the coverage range; and
3) partial-coverage: among two remote UEs and a relay UE, at least one UE is in the coverage range, and at least one UE is out of the coverage range.

Wherein, the coverage range refers to the coverage range of a base station.

UE-to-network relaying is as shown in FIG. 2. In scenario 1 ((A) in FIG. 2) and scenario 2 ((B) in FIG. 2), on the left is a remote UE, in the middle is a relay UE, and on the right is a network (also referred to as a base station, a network, or an NW in the present specification). In scenario 3 ((C) in FIG. 2), on the two sides are networks, and a remote UE and a relay UE are sequentially from left to right in the middle. The remote UE and the relay UE are connected to each other by means of a PC5 interface, and the relay UE is connected to the network by means of a Uu interface. Because the remote UE is far from the network or because the communication environment is poor, the relay UE is needed to relay and forward signaling and data between the remote UE and the network.

UE-to-network relay scenarios include:
1) the remote UE is out of the coverage range, and the relay UE is in the coverage range;
2) the remote UE and the relay UE are both in the coverage range, and are in the same cell; and
3) the remote UE and the relay UE are both in the coverage range, but are not in the same cell.

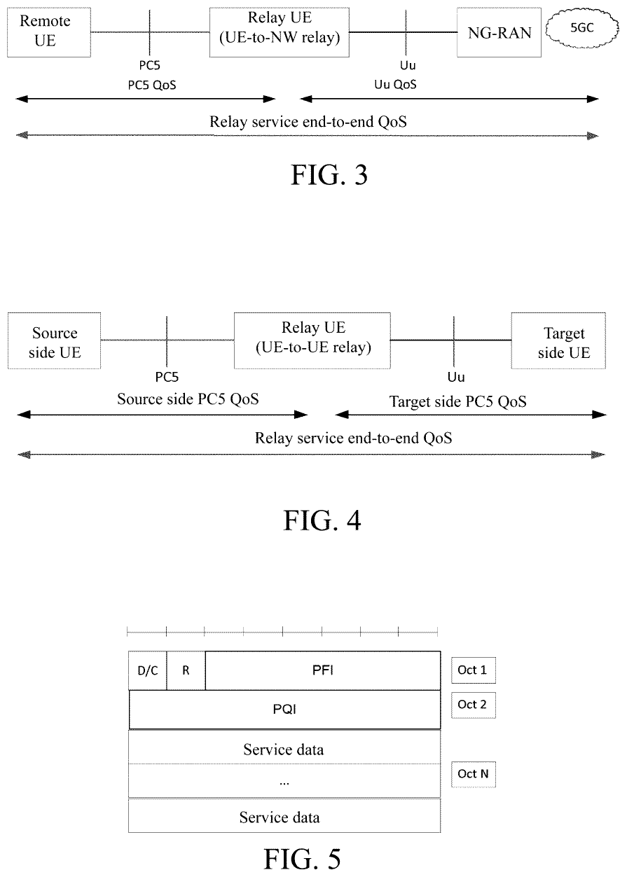

For a UE-to-network relay architecture, as shown in FIG. 3, QoS of a PC5 interface and QoS of a Uu interface are respectively guaranteed, thereby guaranteeing end-to-end QoS. Target end nodes in the present specification include a target side remote UE and an NG-RAN (corresponding to a base station).

On the control plane, a QoS parameter can be negotiated and modified between the remote UE and the UE-to-NW relay by means of PC5-S signaling, and a QoS parameter can be negotiated and modified between the UE-to-NW relay and the NG-RAN by means of NAS signaling. On the user plane, upon receiving data transmitted by the remote UE, the relay UE can find a suitable Uu interface resource according to QoS requirements to perform data transmission, so as to meet end-to-end QoS requirements. Similarly, upon receiving data transmitted by the NG-RAN, the relay UE also needs to find a suitable PC5 interface resource according to QoS requirements to perform data transmission.

For a UE-to-UE relay architecture, as shown in FIG. 4, QoS of a source side PC5 interface and QoS of a target side PC5 interface are respectively guaranteed, thereby guaranteeing end-to-end QoS. The source UE and the target UE are both remote UEs (the target UE may also be referred to as Destination UE).

A QoS parameter can be negotiated and modified between the source UE and the UE-to-UE relay and between the UE-to-UE relay and the target UE by means of PC5-S signaling. On the user plane, upon receiving data transmitted by the source UE, the relay UE can find a suitable target side PC5 interface resource according to QoS requirements to perform data transmission, so as to meet end-to-end QoS requirements. Similarly, upon receiving data transmitted by the target UE, the relay UE also needs to find a suitable source side PC5 interface resource according to QoS requirements to perform data transmission.

In addition, the relay UE may further perform QoS splitting according to the end-to-end QoS requirements. For a UE-to-NW relay architecture, QoS requirements are split into QoS requirements on the PC5 interface and QoS requirements on the Uu interface. For a UE-to-UE relay architecture, QoS requirements are split into QoS requirements on the source side PC5 interface and QoS requirements on the target side PC5 interface.

The relay UE notifies, by means of signaling, the remote UE or the network of QoS requirements resulting from the splitting. For different QoS requirements, different SL QoS flow bearers are set up on the PC5 interface, and different Uu QoS flow bearers are set up on the Uu interface. An SL QoS flow is identified by a PQFI, and a Uu QoS flow is identified by a QFI. At the AS layer, the QoS flow is borne by a radio bearer, and different radio bearers may correspond to different RLC channels.

For PC5 interface user plane transmission, SDAP layer data PDUs have two formats: with header and without header, and the header includes a PQFI. For Uu interface user plane transmission, SDAP layer data PDUs also have two formats: with header and without header, and the header includes a QFI.

The following describes in detail several embodiments of the present invention regarding how a remote UE configures QoS information to be carried to enable a relay UE to perform data forwarding, and how a relay UE performs QoS splitting to guarantee QoS requirements in various NR sidelink relay scenarios.

### Embodiment 1

For a UE-to-network relay architecture, a relay UE may split end-to-end QoS requirements into QoS requirements (corresponding to source side QoS) on a PC5 interface (corresponding to a source side channel) and QoS requirements (corresponding to target side QoS) on a Uu interface (corresponding to a target side channel). For a UE-to-UE relay architecture, a relay UE may split end-to-end QoS requirements into source side QoS requirements and target side QoS requirements.

For the UE-to-network relay architecture, when the relay UE performs QoS splitting:
1) optionally, if PC5 interface SL-RSRP is higher than Uu interface RSRP, the PC5 interface is assigned with more QoS requirements than the Uu interface, that is, the PC5 interface needs to meet higher QoS requirements (e.g., a shorter latency, a greater transmission speed, etc.); conversely, if PC5 interface SL-RSRP is lower than Uu interface RSRP, the PC5 interface is assigned with less QoS requirements than the Uu interface, that is, the PC5 interface needs to meet lower QoS requirements;
2) optionally, if PC5 interface SD-RSRP is higher than Uu interface RSRP, the PC5 interface is assigned with more QoS requirements than the Uu interface, that is, the PC5 interface needs to meet higher QoS requirements; conversely, if PC5 interface SD-RSRP is lower than Uu interface RSRP, the PC5 interface is assigned with less QoS requirements than the Uu interface, that is, the PC5 interface needs to meet lower QoS requirements.

Wherein, the PC5 interface SL-RSRP and the Uu interface RSRP may be compared in one of the following manners:
1) optionally, the PC5 interface SL-RSRP and the Uu interface RSRP are compared directly;
2) optionally, the product of the PC5 interface SL-RSRP multiplied by a coefficient is compared with the Uu interface RSRP; and
3) optionally, the PC5 interface SL-RSRP is compared with the product of the Uu interface RSRP multiplied by a coefficient.

Wherein, the PC5 interface SD-RSRP and the Uu interface RSRP may be compared in one of the following manners:
1) optionally, the PC5 interface SD-RSRP and the Uu interface RSRP are compared directly;
2) optionally, the product of the PC5 interface SD-RSRP multiplied by a coefficient is compared with the Uu interface RSRP; and
3) optionally, the PC5 interface SD-RSRP is compared with the product of the Uu interface RSRP multiplied by a coefficient.

For the UE-to-UE relay architecture, when the relay UE performs QoS splitting (in the scenario, a source side PC5 interface corresponds to a source side channel, and a target side PC5 interface corresponds to a target side channel):
1) optionally, if source side SL-RSRP is higher than target side SL-RSRP, the source side is assigned with more QoS requirements than the target side, that is, the source side needs to meet higher QoS requirements; conversely, if source side SL-RSRP is lower than target side SL-RSRP, the source side is assigned with less QoS requirements than the target side, that is, the source side needs to meet lower QoS requirements;
2) optionally, if source side SD-RSRP is higher than target side SD-RSRP, the source side is assigned with more QoS requirements than the target side, that is, the source side needs to meet higher QoS requirements; conversely, if source side SD-RSRP is lower than target side SD-RSRP, the source side is assigned with less QoS requirements than the target side, that is, the source side needs to meet lower QoS requirements;
3) optionally, if source side SL-RSRP is higher than target side SD-RSRP, the source side is assigned with more QoS requirements than the target side, that is, the source side needs to meet higher QoS requirements; conversely, if source side SL-RSRP is lower than target side SD-RSRP, the source side is assigned with less QoS requirements than the target side, that is, the source side needs to meet lower QoS requirements; and
4) optionally, if source side SD-RSRP is higher than target side SL-RSRP, the source side is assigned with more QoS requirements than the target side, that is, the source side needs to meet higher QoS requirements; conversely, if source side SD-RSRP is lower than target side SL-RSRP, the source side is assigned with less QoS requirements than the target side, that is, the source side needs to meet lower QoS requirements; and
5) optionally, if a source side CBR is higher than a target side CBR, the source side is assigned with less QoS requirements than the target side, that is, the source side needs to meet lower QoS requirements; conversely, if the source side CBR is lower than the target side CBR, the source side is assigned with more QoS requirements than the target side, that is, the source side needs to meet higher QoS requirements.

The SD-RSRP and the SL-RSRP may be compared, for example in the above cases 3) and 4), in one of the following manners:
1) optionally, the SD-RSRP and the SL-RSRP are compared directly;
2) optionally, the product of the SD-RSRP multiplied by a coefficient is compared with the SL-RSRP; and
3) optionally, the SD-RSRP is compared with the product of the SL-RSRP multiplied by a coefficient.

It should be noted that comparison between a source side channel indicator and a target side channel indicator mentioned in the present specification includes comparing the source side channel indicator and the target side channel indicator directly, or respectively multiplying the source side channel indicator and the target side channel indicator by corresponding coefficients, and then comparing acquired products. Further, the above case in which the product of one of the source side channel indicator and the target side channel indicator multiplied by a coefficient is compared with the other may be regarded as the case in which the coefficient of the other is 1. For example, when it is mentioned that the source side SD-RSRP is higher than the target side SL-RSRP, the source side SD-RSRP and the target side SL-RSRP may be compared directly, so as to determine whether the source side SD-RSRP is higher than the target side SL-RSRP; alternatively, the source side SD-RSRP and the target side SL-RSRP may be respectively multiplied by corresponding coefficients, and the two are then compared according to resulting products.

### Embodiment 2

Optionally, after a remote UE and a relay UE have set up a PC5 unicast link, the relay UE configures a sidelink DRB for the remote UE by means of an RRCReconfigurationSidelink message (a sidelink RRC reconfiguration message) including an IE, i.e., sl-SDAP-Header. If a first condition is met, the relay UE sets sl-SDAP-Header in the RRCReconfigurationSidelink message to present.

Optionally, the remote UE acquires, by means of pre-configuration information, a sidelink DRB configuration including an IE, i.e., sl-SDAP-Headerr. If the first condition is met, the IE is set to present.

Optionally, the remote UE acquires, by means of base station configuration information, a sidelink DRB configuration including an IE, i.e., sl-SDAP-Header. If the first condition is met, the IE is set by a base station to present.

The first condition is one of the following:
1) optionally, the sidelink DRB is for sidelink relay;
2) optionally, the sidelink DRB is used by the relay UE to forward service data of the remote UE;
3) optionally, an upper layer indicates that the sidelink DRB is for sidelink relay; and
4) optionally, an upper layer indicates that the sidelink DRB is used by the relay UE to forward service data of the remote UE.

If sl-SDAP-Header is set to present, when the remote UE transmits a sidelink SDAP data PDU, the remote UE constructs the sidelink SDAP data PDU in a format with an SDAP header according to the configuration.

### Embodiment 3

On the basis of Embodiment 2, identification information indicating whether an SDAP header dedicated to sidelink relay is carried or not, such as an IE, i.e., slrelay-SDAP-Header, is added to the sidelink DRB configuration.

Optionally, after a remote UE and a relay UE have set up a PC5 unicast link, the relay UE configures a sidelink DRB for the remote UE by means of an RRCReconfigurationSidelink message including slrelay-SDAP-Header. If a first condition is met, the relay UE sets slrelay-SDAP-Header in the RRCReconfigurationSidelink message to present.

Optionally, the remote UE acquires, by means of pre-configuration information, a sidelink DRB configuration including slrelay-SDAP-Header. If the first condition is met, the IE is set to present.

Optionally, the remote UE acquires, by means of base station configuration information, a sidelink DRB configuration including slrelay-SDAP-Header. If the first condition is met, the IE is set by a base station to present.

The first condition is the same as that in Embodiment 2.

If slrelay-SDAP-Header is set to present, when the remote UE transmits a sidelink SDAP data PDU, the remote UE constructs the sidelink SDAP data PDU in a format with an SDAP header according to the configuration.

### Embodiment 4

On the basis of Embodiment 3, a sidelink SDAP header format dedicated to sidelink relay is added, and compared with SDAP headers in the prior art, PQI information is added, such as, but not limited to, the format shown in FIG. 5.

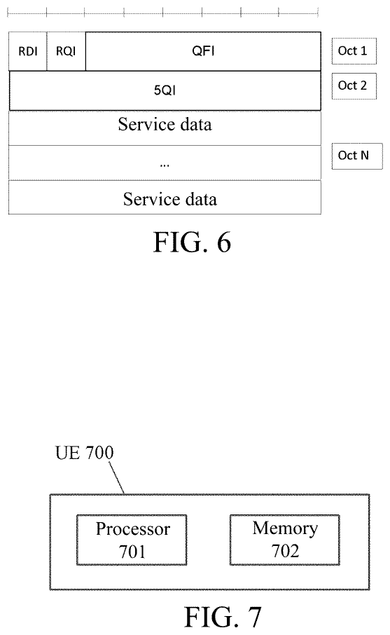

A Uu interface SDAP header format dedicated to sidelink relay may also be added, and compared with SDAP headers in the prior art, 5QI is added, such as, but not limited to, the format shown in FIG. 6.

Whether a new sidelink SDAP header or a new Uu interface SDAP header is carried or not may be configured according to slrelay-SDAP-Header in Embodiment 3.

In addition, for a PC5 interface when serving as a data receiving party, if slrelay-SDAP-Header in the sidelink DRB configuration is configured to be present, the UE needs to acquire an SL SDAP SDU from an SL SDAP PDU according to the new sidelink SDAP header format.

### Embodiment 5

After a remote UE and a relay UE have set up a PC5 unicast link, when the remote UE needs to transmit data, if an SDAP layer determines that an SDAP SDU to be transmitted needs to be relayed, a sidelink SDAP data PDU is configured according to a format with an SDAP header. Further, whether the SDAP SDU needs to be relayed may be indicated by an upper layer to the SDAP layer.

### Embodiment 6

For a UE-to-network relay architecture, when an SL RLC channel is added, modified, or deleted on a PC5 interface and a Uu RLC channel is added, modified, or deleted on a Uu interface, a relay UE stores a mapping relationship between the SL RLC channel and the Uu RLC channel. In the present specification, when channel modification is mentioned, said modification includes adding a new channel, modifying an existing channel, deleting an existing channel, etc. According to QoS requirements, service data on the PC5 interface and service data on the Uu interface are borne by different QoS procedures. Further, at the AS layer, the different QoS procedures are borne by different radio bearers, and the different radio bearers are borne by different RLC channels. Thus, different RLC channel configurations correspond to QoS requirements of different service data. For data transmission from a remote UE to a network, when the relay UE receives data on a certain SL RLC channel, and if no corresponding Uu RLC channel can be found according to the stored mapping relationships between RLC channels, a Uu RLC entity is created to transmit the data; or, if a corresponding Uu RLC channel can be found according to the stored mapping relationships between RLC channels, the data is transmitted on the corresponding Uu RLC channel. Conversely, for data transmission from a network to a remote UE, when the relay UE receives data on a certain Uu RLC channel, and if no corresponding SL RLC channel can be found according to stored mapping relationships between RLC channels, an SL RLC entity is created to transmit the data; or, if a corresponding SL RLC channel can be found according to the stored mapping relationships between RLC channels, the data is transmitted on the corresponding SL RLC channel.

For a UE-to-UE relay architecture, when an SL RLC channel is added, modified, or deleted on a source side, and an SL RLC channel is added, modified, or deleted on a target side, a relay UE stores a mapping relationship between the source side SL RLC channel and the target side SL RLC channel. For data transmission from a source side UE to a target side UE, when the relay UE receives data on a certain source side SL RLC channel, and if no corresponding target side SL RLC channel can be found according to stored mapping relationships between RLC channels, a target side RLC entity is created to transmit the data; or if a corresponding target side SL-RLC channel can be found according to the stored mapping relationships between RLC channels, the data is transmitted on the corresponding target side SL-RLC channel. For data transmission from a target side UE to a source side UE, the processing procedure is the same, and only the target side and the source side in the above actions need to be interchanged, so details will not be described herein again.

FIG. 7 is a schematic structural block diagram of user equipment (UE) according to the present invention. As shown in FIG. 7, user equipment (UE) 700 includes a processor 701 and a memory 702. The processor 701 may include, for example, a microprocessor, a microcontroller, an embedded processor, and the like. The memory 702 may include, for example, a volatile memory (such as a random access memory (RAM)), a hard disk drive (HDD), a non-volatile memory (such as a flash memory), or other memories. The memory 702 stores program instructions. The instructions, when run by the processor 701, can implement the above method performed by user equipment as described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing them by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A User Equipment (UE), comprising a processor configured to:
in case the UE is a UE-to-UE (U2U) relay UE, the UE splits QoS requirement between a source side remote UE and a target side remote UE into a source side QoS requirement and a target side QoS requirement based on a source side SL-RSRP and a target side SL-RSRP.

12. The UE according to claim 11, the processor is further configured to:
in case the source side SL-RSRP is higher than the target side SL-RSRP, sets the source side QoS requirement higher than the target side QoS requirement, and
in case the source side SL-RSRP is lower than the target side SL-RSRP, sets the source side QoS requirement lower than the target side QoS requirement.

13. A User Equipment (UE), comprising a processor configured to:
in case the UE is a UE-to-UE (U2U) relay UE, the UE splits QoS requirement between a source side remote UE and a target side remote UE into a source side QoS requirement and a target side QoS requirement based on a source side CBR and a target side CBR.

14. The UE according to claim 13, the processor is further configured to:
in case the source side CBR is lower than the target side CBR, sets the source side QoS requirement higher than the target side QoS requirement, and
in case the source side CBR is higher than the target side CBR, sets the source side QoS requirement lower than the target side QoS requirement.
